(19) United States
(12) Patent Application Publication
(10) Pub. No.: US 2023/0230341 A1
(43) Pub. Date: Jul. 20, 2023

(54) CONCEPT BASED SEGMENTATION

(71) Applicant: Cortica Ltd., Tel Aviv (IL)

(72) Inventor: Karina Odinaev, Tel Aviv (IL)

(73) Assignee: Cortica Ltd., Tel Aviv (IL)

(21) Appl. No.: 18/155,725

(22) Filed: Jan. 17, 2023

Related U.S. Application Data
(60) Provisional application No. 63/266,865, filed on Jan. 17, 2022.

(51) Int. Cl. G06V 10/26; G06V 10/44; G06V 10/20; G06V 10/774

(52) U.S. Cl. CPC G06V 10/26; G06V 10/44; G06V 10/255; G06V 10/774; G06V 2201/10

(57) ABSTRACT

A method for concept based segmentation, the method may include (a) detecting an object within a region of an image; wherein the object is associated with characteristic pixels metadata that indicative of multiple examples of pixels properties of pixels that are included in at least one appearance of the object within at least one image; and (b) finding, within the region, one or more object boundaries, based on the characteristic pixels metadata.

### BACKGROUND

Segmentation of images may be inaccurate—especially when the background of the object has the same color as the object.

Rule based segmentation may be complex and require to learn each object to provide an accurate segmentation.

There is a growing need to provide an accurate segmentation process.

### SUMMARY

A method, system and non-transitory computer readable medium for concept based segmentation.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a guinea pig;

FIG. 3 illustrates an example of a scanned image of a guinea pig;

FIG. 4 illustrates an example of an image of a black cat; and

FIG. 5 illustrates an example of a system and data structures.

### DESCRIPTION OF EXAMPLE EMBODIMENTS

The specification and/or drawings may refer to an image. An image is an example of a media unit. Any reference to an image may be applied mutatis mutandis to a media unit. A media unit may be an example of sensed information. Any reference to a media unit may be applied mutatis mutandis to a natural signal such as but not limited to signal generated by nature, signal representing human behavior, signal representing operations related to the stock market, a medical signal, and the like. Any reference to a media unit may be applied mutatis mutandis to sensed information. The sensed information may be sensed by any type of sensors—such as a visual light camera, or a sensor that may sense infrared, radar imagery, ultrasound, electro-optics, radiography, LIDAR (light detection and ranging), etc.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There may be provide a system, a method and a non-transitory computer readable medium for concept based segmentation.

The solution is accurate as it is based on characteristic pixel metadata—which allows to segment between objects to their background—even when the background is similar to the object, it also allows to manage objects with different portions—by segmenting the portions—and also by applying the relevant characteristic pixels metadata to a portion of the object and thus allow to accurately distinguish the portion from an adjacent background.

The solution is adaptive in the sense that it may update the characteristic pixel metadata and even generate new characteristic pixel metadata—following a processing of new images.

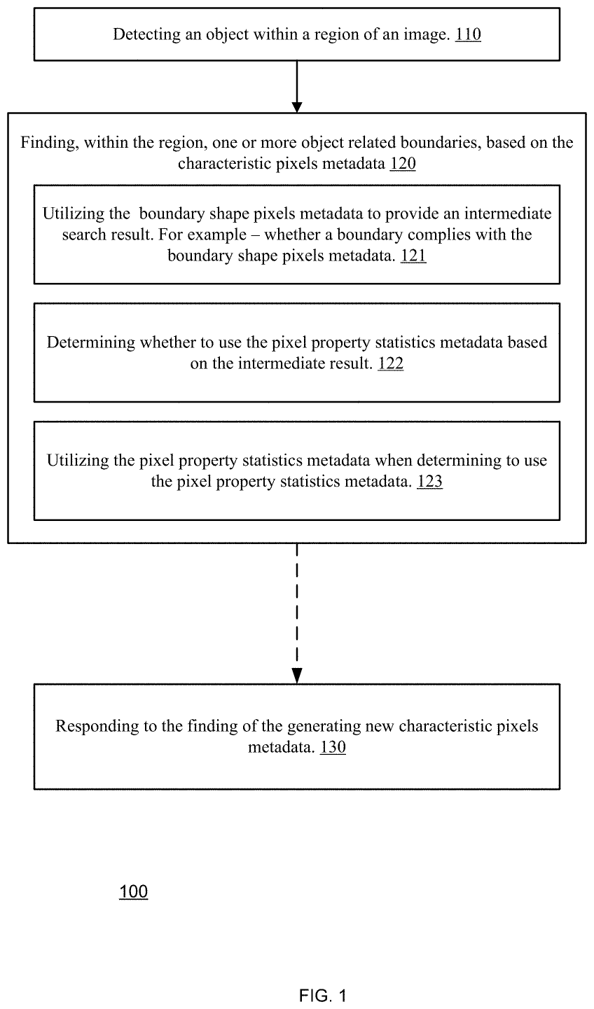

FIG. 1 is an example of a method 100 for concept based segmentation. Method 100 may be executed on a vast number of images (thousands, tens of thousands) in real time—within less than a second—and without human intervention.

Method 100 may start by step 110 of detecting an object within a region of an image.

Step 110 may include applying any type of object detection—for example machine learning based object detection, rule based object detection, non-machine learning based object detection, and the like.

The object is associated with characteristic pixels metadata. The characteristic pixels metadata is indicative of multiple examples of pixels properties of pixels that are included in at least one appearance of the object within at least one image.

The characteristic pixels metadata may be indicative of at least one out of:
Shapes of boundary segments of the object.
Shapes of boundary segments of one or more object portions.
Pixels property statistics of the object.
Pixels property statistics of one or more object portions.

A boundary segment is a part of a boundary.

It should be noted that shape of boundary segments and pixels property statistics may be associated with each other—for example an object portion may be detected only when it has a boundary that corresponds with a certain shape of boundary segment and includes pixels that exhibit a certain pixel property statistics.

The statistics may include mean, median, standard deviation, any other higher order moment, and the like. The statistics may be related to any property of the pixel—for example any color, gray level, brightness, and the like.

The object may include different object portions that differ from each other and correspond to different examples of the pixels properties. In this case the characteristic pixels metadata may include pixels properties of at least some (and preferably of each) of the different object portions. Having the metadata of the different object portions may assist in segmenting the object to the different object portions. An edge between one object portion to another object portion (that has different pixel properties) may be detected by finding one or more edge pixels of the object that exhibits properties that comply with at least one example of the pixels properties, and has one or more neighboring pixel that exhibits properties that do not comply with at least one example of the pixel properties.

The object may be scanned or otherwise sampled to find the edges between different object portions.

The characteristic pixels metadata of the object (as well as other objects) may be stored in one or more database.

The characteristic pixels metadata of the object may belong to a concept structure such as but not limited to a cluster. The cluster may include signatures of the object (or signatures of objects of the same type of the object). The cluster may be generated based, at least in part, on images of the object or images of objects of the same type of the object.

A non-limiting for generating signatures and clusters is illustrated in US patent application 2020/0311464 which is incorporated herein by reference.

Step 110 may be followed by step 120 of finding, within the region, one or more object related boundaries, based on the characteristic pixels metadata.

An object related boundary may be a boundary of the object. An object related boundary may be a boundary between different object portions that differ from each other and correspond to different examples of the pixels properties.

Step 120 may include at least one of:
Finding, within the region, one or more object boundaries.
Finding, within the region, one or more object portion boundaries.

When the characteristic pixels metadata includes shapes of boundary segments of the object then the object may be segmented from background—even when at the boundary of the object the pixels of the object and the background have similar pixels property statistics. The same applies to differentiating between different object portions.

For example—step 120 may include:
Step 121 of utilizing the boundary shape pixels metadata to provide an intermediate search result. For example—whether a boundary complies with the boundary shape pixels metadata.
Step 122 of determining whether to use the pixel property statistics metadata based on the intermediate result. For example—if the boundary does not comply—there may no need to check the pixel property statistics. Yet for another example—when the boundary complies and it indicates that a valid boundary of the object was found—then there may no need to check the pixel property statistics metadata.
Step 123 of utilizing the pixel property statistics metadata when determining to use the pixel property statistics metadata.

Step 120 may be followed by step 130 of responding to the finding of the generating new characteristic pixels metadata.

Step 130 may include updating characteristic pixels metadata and/or generating new characteristic pixels metadata based on pixels characters of the object processed during step 120.

Step 130 may include providing object information, storing the object information, and/or transmitting the object information. The object information may refer to the object—shape, size, boundaries, and/or to any portion of the object and/or to any pixels of the object.

The object information may be used for object detection, object classification, object evaluation, generation of cropped images, training machine learning processes, evaluating machine learning processes, and the like.

The object information may assist in navigating a drone or a robot or a vehicle within an environment that includes objects.

Step 130 may include at least one of:
Performing an autonomous robot movement.
Instructing (or requesting) an autonomous movement module of a robot to perform an autonomous robot movement.
Transmitting a request (or an instruction) to the autonomous movement module of a robot to perform an autonomous robot movement.
Providing information about the object.
Suggesting a robot movement to a human operator.

The image that includes the object may be associated with one or more concept structures—for example—including the signature of the image (of a part of the image) and at least a part of the object information in one or more concept structures.

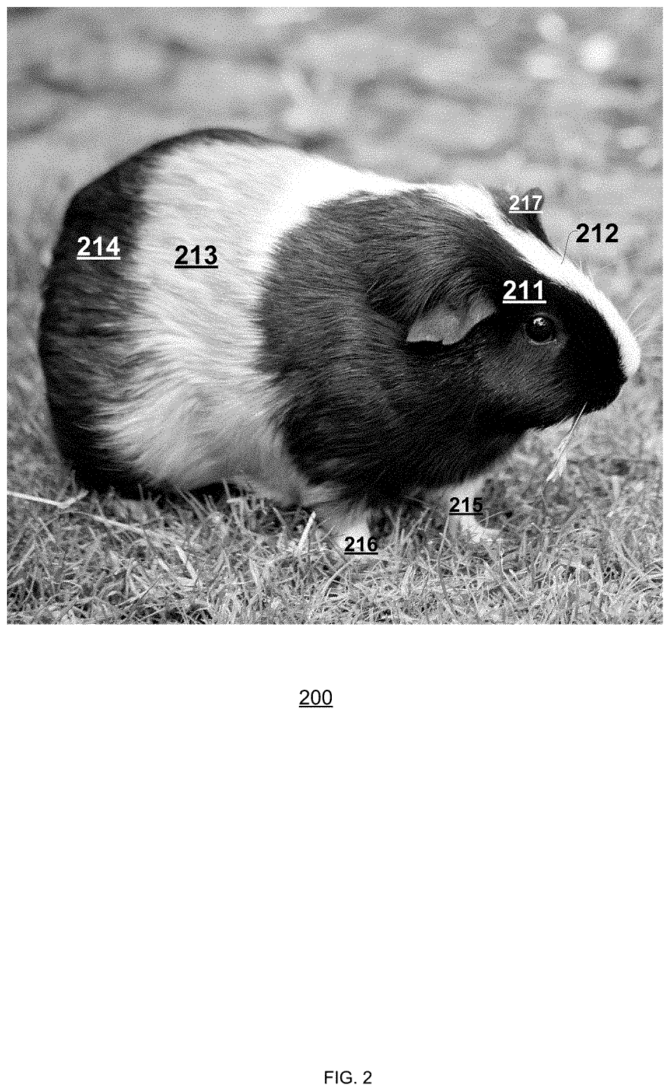

FIG. 2 is an example of an image 200 of a guinea pig. The guinea pig has six portions—first black portion 211, a first white portion 212, a first brown portion 213, a second black portion 214, a second white portion 215, a third white portion 216 and a third black portion 217.

The guinea pig may be detected using object detection and then its boundaries and the boundaries of its portions may be detected during a segmentation process.

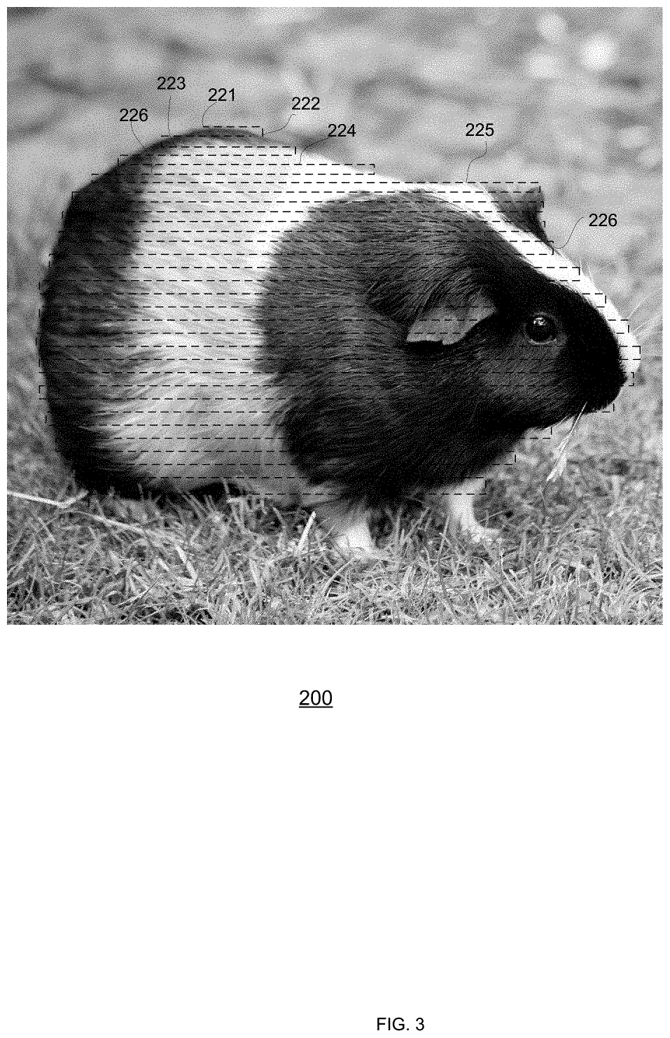

FIG. 3 is an example of a scanning of the image of the guinea pig. The scanning starts at first scan point 221 and continues to second scan point 222 of finding a boundary of the guinea pig.

This may be based on characteristic pixels metadata such as at least one out of (a) characteristic pixels metadata of the guinea pig that differs from characteristic pixels metadata of the background, (b) a mismatch between background pixels to the characteristic pixels metadata of the guinea pig, and/or (c) shapes of boundary segments of the guinea pig and/or shapes of boundary segments of the guinea pig second black portion 214.

Different points of the scan pattern include a third scan point 223 (edge point on a boundary between first brown portion 213 and second black portion 214), fourth scan point 224 (edge point on a boundary between first brown portion 213 and first white portion 212), fifth scan point 225 (edge point on a boundary between the first white portion 212 and the background), and sixth scan point 226 (edge point on a boundary between third black portion 217 and the background).

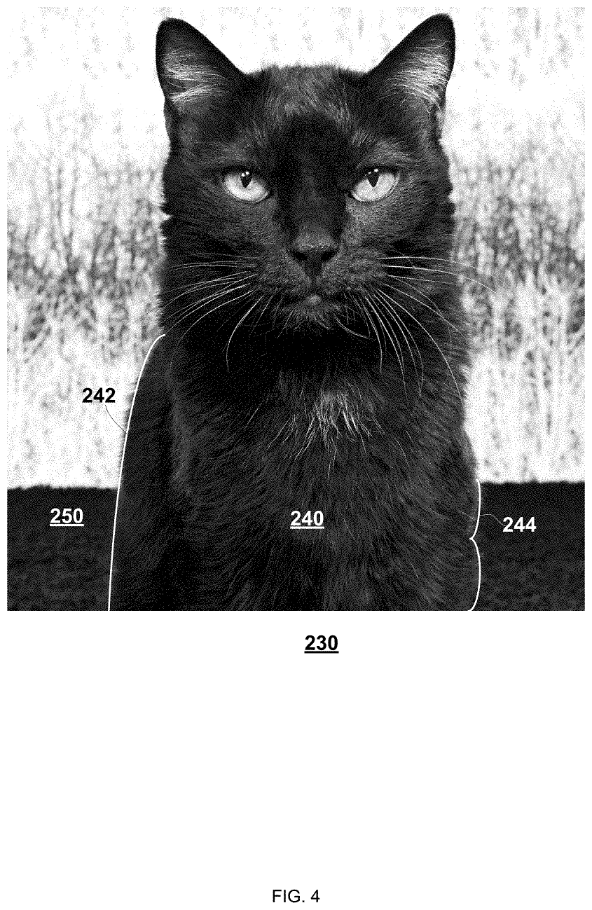

FIG. 4 is an example of an image 230 of a black cat 240 that has a background that has a black background part 250.

In this case the finding of the boundaries 242 and 244 between the black cat 240 and the black background part may be determined based on boundary shape pixels metadata.

There may be provide a system for concept based segmentation, the system comprises one or more processing circuitries that are configured to (a) detect an object within a region of an image; wherein the object is associated with characteristic pixels metadata that indicative of multiple examples of pixels properties of pixels that are included in at least one appearance of the object within at least one image; and find, within the region, one or more object boundaries, based on the characteristic pixels metadata.

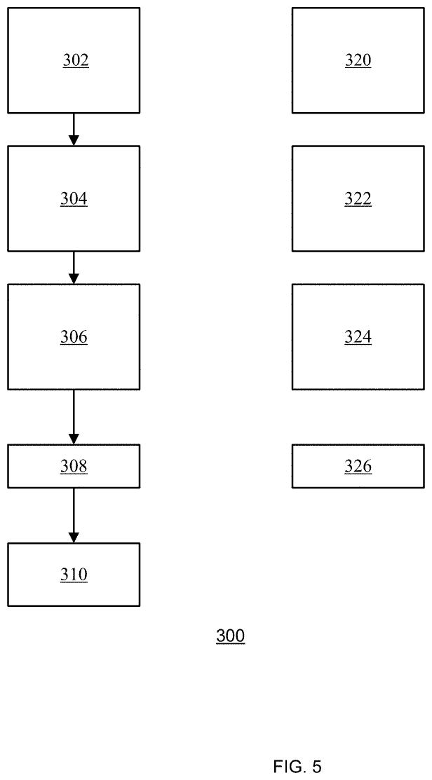

FIG. 5 illustrates a system 300 and various data structures.

The system 300 includes at least one of the following:
Characteristic pixels metadata generator 302 configured to generate and/or update characteristic pixels metadata.
Object detector 304 for detecting an object within a region of an image.
Signature generator 306 configured to generate image signatures.
Concept structure generator 308 configured to generate concept structures based at least on part on image signatures.
Segmentation engine 310 that is configured to find within one or more regions of an image the one or more object related boundaries.

The data structures may include one or more concept structures 320, one or more images 322, one or more image signatures 324, and characteristic pixels metadata 326. The one or more concept structures 320 may include at least some of the one or more image signatures 324 and at least some of the characteristic pixels metadata 326.

An image not represented in the one or more concept structures may be processed by method 100 and have related signatures and/or metadata be added on one or more of the concept structures 320.

Any one of the metadata generator 302, object detector 304, signature generator 306, concept structure generator 308 and segmentation engine 310 may be implemented by one or more processing circuitry and/or may be executed by one or more processing circuitry and/or may implement a machine learning process or may not implement a machine learning process.

Autonomous segmentation may be regarded as one of the building blocks of various algorithms—such as machine vision—and the suggested highly accurate and resource efficient solution provide substantial technical improvement in the field of computer science.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by a system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on non-transitory computer readable media permanently, removably or remotely coupled to an information processing system. The non-transitory computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for concept based segmentation, the method comprises:
detecting an object within a region of an image; wherein the object is associated with characteristic pixels metadata that indicative of multiple examples of pixels properties of pixels that are included in at least one appearance of the object within at least one image; and
finding, within the region, one or more object boundaries, based on the characteristic pixels metadata.

2. The method according to claim 1 wherein the characteristic pixels metadata is indicative of shapes of boundary segments of the object.

3. The method according to claim 1 wherein the characteristic pixels metadata is indicative of pixels property statistics.

4. The method according to claim 1 wherein the characteristic pixels metadata comprises (a) boundary shape pixels metadata that is indicative of shapes of boundary segments of the object, and (b) pixels property statistics metadata that is indicative of pixel property statistics.

5. The method according to claim 4 wherein the finding comprises utilizing the boundary shape pixels metadata and the pixel property statistics metadata.

6. The method according to claim 4 wherein the finding comprises utilizing the boundary shape pixels metadata to provide an intermediate search result, determining whether to use the pixel property statistics metadata based on the intermediate result, and utilizing the pixel property statistics metadata when determining to use the pixel property statistics metadata.

7. The method according to claim 1 wherein the object comprises different object portions that differ from each other and correspond to different examples of the pixels properties.

8. The method according to claim 1 wherein the finding comprises scanning the region to find edge pixels of the object, wherein an edge pixel of the object (a) exhibits properties that comply with at least one example of the pixels properties, and (b) has one or more neighboring pixel that exhibits properties that do not comply with at least one example of the pixel properties.

9. The method according to claim 1 wherein the characteristic pixels metadata is arranged in one or more concept structures.

10. The method according to claim 1 wherein the finding is executed by a machine learning process.

11. A non-transitory computer readable medium for concept based segmentation, the non-transitory computer readable medium comprises:
detecting an object within a region of an image; wherein the object is associated with characteristic pixels metadata that indicative of multiple examples of pixels properties of pixels that are included in at least one appearance of the object within at least one image; and
finding, within the region, one or more object boundaries, based on the characteristic pixels metadata.

12. The non-transitory computer readable medium according to claim 11 wherein the characteristic pixels metadata is indicative of shapes of boundary segments of the object.

13. The non-transitory computer readable medium according to claim 11 wherein the characteristic pixels metadata is indicative of pixels property statistics.

14. The non-transitory computer readable medium according to claim 11 wherein the characteristic pixels metadata comprises (a) boundary shape pixels metadata that is indicative of shapes of boundary segments of the object, and (b) pixels property statistics metadata that is indicative of pixel property statistics.

15. The non-transitory computer readable medium according to claim 14 wherein the finding comprises utilizing the boundary shape pixels metadata and the pixel property statistics metadata.

16. The non-transitory computer readable medium according to claim 14 wherein the finding comprises utilizing the boundary shape pixels metadata to provide an intermediate search result, determining whether to use the pixel property statistics metadata based on the intermediate result, and utilizing the pixel property statistics metadata when determining to use the pixel property statistics metadata.

17. The non-transitory computer readable medium according to claim 11 wherein the object comprises different object portions that differ from each other and correspond to different examples of the pixels properties.

18. The non-transitory computer readable medium according to claim 11 wherein the finding comprises scanning the region to find edge pixels of the object, wherein an edge pixel of the object (a) exhibits properties that comply with at least one example of the pixels properties, and (b) has one or more neighboring pixel that exhibits properties that do not comply with at least one example of the pixel properties.

19. The non-transitory computer readable medium according to claim 11 wherein the characteristic pixels metadata is arranged in one or more concept structures.

20. A system for concept based segmentation, the system comprises one or more processing circuitries that are configured to:
detect an object within a region of an image; wherein the object is associated with characteristic pixels metadata that indicative of multiple examples of pixels properties of pixels that are included in at least one appearance of the object within at least one image; and
find, within the region, one or more object boundaries, based on the characteristic pixels metadata.
